(19) United States
(12) Patent Application Publication
(10) Pub. No.: US 2025/0192856 A1
(43) Pub. Date: Jun. 12, 2025

(54) BEAM SWITCH PREDICTION AND REPORTING

(71) Applicant: QUALCOMM INCORPORATED, San Diego, CA (US)

(72) Inventors: Tianyang Bai, Mountain View, CA (US); Yan Zhou, San Diego, CA (US); Hua Wang, Basking Ridge, NJ (US); Qiaoyu Li, Beijing (CN); Hamed Pezeshki, San Diego, CA (US); Mahmoud Taherzadeh Boroujeni, San Diego, CA (US); Taesang Yoo, San Diego, CA (US); Vasanthan Raghavan, West Windsor Township, NJ (US); Junyi Li, Greentown, PA (US); Tao Luo, San Diego, CA (US)

(21) Appl. No.: 18/843,661

(22) PCT Filed: Apr. 29, 2022
(86) PCT No.: PCT/CN2022/090540

§ 371 Date: Sep. 3, 2024

(51) Int. Cl. H04B 7/06; H04W 36/08; H04W 36/32

(52) U.S. Cl. CPC H04B 7/0695; H04W 36/085; H04W 36/322

(57) ABSTRACT

Methods, systems, and devices for wireless communications are described. A user equipment (UE) may use a first communication beam to communicate with a network entity. While using the first communication beam, the UE may determine a second communication beam for use after the first communication beam. Based on the determination, the UE may predict a change in a communication parameter of the UE associated with to the second communication beam. Before switching from the first communication beam to the second communication beam, the UE may transmit to the network entity a message that indicates the predicted change in the communication parameter and a time to switch to the second communication beam.

### CROSS REFERENCE

The present application is a 371 national stage filing of International PCT Application No. PCT/CN2022/090540 by Bai et al. entitled “BEAM SWITCH PREDICTION AND REPORTING,” filed Apr. 29, 2022, which is assigned to the assignee hereof, and which is expressly incorporated by reference in its entirety herein.

### FIELD OF TECHNOLOGY

The following relates to wireless communications, including beam switch prediction and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may use a communication beam to communicate with a network entity. Improved techniques for switching between communication beams may be desired.

### SUMMARY

The described techniques relate to improved methods, systems, devices, and apparatuses that support beam switch prediction and reporting. A user equipment (UE) may use a first communication beam (e.g., a transmit beam, a receive beam) to communicate with a network entity. While using the first communication beam, the UE may determine (e.g., using machine learning, using artificial intelligence) a second communication beam for use after the first communication beam. Based on the determination, the UE may predict a change in a communication parameter of the UE associated with to the second communication beam. Before switching from the first communication beam to the second communication beam, the UE may transmit to the network entity a message that indicates the predicted change in the communication parameter and a time to switch to the second communication beam.

A method for wireless communication at a user equipment (UE) is described. The method may include communicating, with a network entity, using a first communication beam, determining a second communication beam to use for communicating with the network entity after using the first communication beam, predicting a change in a communication parameter of the UE associated with switching from the first communication beam to the second communication beam, and transmitting, to the network entity before switching to the second communication beam, a message that indicates the predicted change in the communication parameter and a time parameter, the time parameter indicating a time to switch to the second communication beam.

An apparatus for wireless communication is described. The apparatus may include a memory, a transceiver, and at least one processor of a UE, the at least one processor coupled with the memory and the transceiver. The at least one processor may be configured to communicate, with a network entity, using a first communication beam, determine a second communication beam to use for communicating with the network entity after using the first communication beam, predict a change in a communication parameter of the UE associated with switching from the first communication beam to the second communication beam, and transmit, to the network entity before switching to the second communication beam, a message that indicates the predicted change in the communication parameter and a time parameter, the time parameter indicating a time to switch to the second communication beam.

Another apparatus for wireless communication at a UE is described. The apparatus may include means for communicating, with a network entity, using a first communication beam, means for determining a second communication beam to use for communicating with the network entity after using the first communication beam, means for predicting a change in a communication parameter of the UE associated with switching from the first communication beam to the second communication beam, and means for transmitting, to the network entity before switching to the second communication beam, a message that indicates the predicted change in the communication parameter and a time parameter, the time parameter indicating a time to switch to the second communication beam.

A non-transitory computer-readable medium storing code for wireless communication at a UE is described. The code may include instructions executable by a processor to communicate, with a network entity, using a first communication beam, determine a second communication beam to use for communicating with the network entity after using the first communication beam, predict a change in a communication parameter of the UE associated with switching from the first communication beam to the second communication beam, and transmit, to the network entity before switching to the second communication beam, a message that indicates the predicted change in the communication parameter and a time parameter, the time parameter indicating a time to switch to the second communication beam.

Some examples of the method, apparatuses, and non-transitory computer-readable medium described herein may further include operations, features, means, or instructions for determining a communication beam for the network entity based on the second communication beam and indicating the communication beam for the network entity before switching from the first communication beam to the second communication beam.

Some examples of the method, apparatuses, and non-transitory computer-readable medium described herein may further include operations, features, means, or instructions for requesting, before switching to the second communication beam, a set of uplink reference signal resources for transmitting an uplink reference signal using the second communication beam.

Some examples of the method, apparatuses, and non-transitory computer-readable medium described herein may further include operations, features, means, or instructions for requesting, before switching to the second communication beam, a downlink reference signal to measure using the second communication beam and transmitting channel state information that may be based on measuring the downlink reference signal using the second communication beam.

Some examples of the method, apparatuses, and non-transitory computer-readable medium described herein may further include operations, features, means, or instructions for requesting, before switching to the second communication beam, the network entity perform a beam sweep procedure after the time to switch to the second communication beam.

Some examples of the method, apparatuses, and non-transitory computer-readable medium described herein may further include operations, features, means, or instructions for determining, based on transmitting the message, a duration of time during which communication with the network entity may be suspended, the duration of time relative to the time to switch to the second communication beam.

In some examples of the method, apparatuses, and non-transitory computer-readable medium described herein, the second communication beam may be determined using machine learning and the method, apparatuses, and non-transitory computer-readable medium may include further operations, features, means, or instructions for determining a change in location of the UE, a change in orientation of the UE, a change in a physical configuration of the UE, a change in a surrounding obstruction, or any combination thereof, where the second communication beam may be determined based on the change in location of the UE, the change in orientation of the UE, the change in a physical configuration of the UE, the change in the surrounding obstruction, or any combination thereof.

In some examples of the method, apparatuses, and non-transitory computer-readable medium described herein, the change in the communication parameter includes a change in multiple-input multiple-output rank or a change in directivity gain.

In some examples of the method, apparatuses, and non-transitory computer-readable medium described herein, the message may be transmitted according to a periodicity.

Some examples of the method, apparatuses, and non-transitory computer-readable medium described herein may further include operations, features, means, or instructions for determining that a threshold duration of time may have elapsed since transmission of a previous message indicating a switch between communication beams, where the message may be transmitted based on determining that the threshold duration of time may have elapsed.

Some examples of the method, apparatuses, and non-transitory computer-readable medium described herein may further include operations, features, means, or instructions for determining that continued use of the first communication beam may be associated with a first predicted signal strength that may be lower than a second predicted signal strength associated with use of the second communication beam, where the message may be transmitted based on the determination that the first predicted signal strength may be lower than the second predicted signal strength.

Some examples of the method, apparatuses, and non-transitory computer-readable medium described herein may further include operations, features, means, or instructions for determining that a duration of time between transmission of the message and the time to switch may be less than a threshold duration of time, where the message may be transmitted based on the determination that the duration of time may be less than the threshold duration of time.

Some examples of the method, apparatuses, and non-transitory computer-readable medium described herein may further include operations, features, means, or instructions for determining that a duration of time between transmission of the message and the time to switch may be greater than a threshold duration of time, where the message may be transmitted based on the determination that the duration of time may be greater than the threshold duration of time.

Some examples of the method, apparatuses, and non-transitory computer-readable medium described herein may further include operations, features, means, or instructions for receiving a second message confirming receipt of the message by the network entity and switching to the second communication beam at the time and based on receiving the second message.

In some examples of the method, apparatuses, and non-transitory computer-readable medium described herein, the message may be conveyed in a physical uplink control channel and the second message may be included in downlink control information for the UE.

In some examples of the method, apparatuses, and non-transitory computer-readable medium described herein, the message may be conveyed in a physical uplink shared channel and the second message may be included in an uplink grant that may have a same hybrid automatic repeat request identifier as the physical uplink shared channel.

In some examples of the method, apparatuses, and non-transitory computer-readable medium described herein, the message may be included in uplink control information or in a medium access control (MAC) control element.

Some examples of the method, apparatuses, and non-transitory computer-readable medium described herein may further include operations, features, means, or instructions for initiating a random access procedure, where the message may be part of the random access procedure.

A method for wireless communication at a network entity is described. The method may include communicating with a UE that is using a first communication beam, receiving a message that indicates a time parameter indicating a time the UE is to switch from the first communication beam to a second communication beam and a predicted change in a communication parameter of the UE associated with switching from the first communication beam to the second communication beam, and changing a configuration of the network entity, a configuration of the UE, or both based on the time parameter and the predicted change in the communication parameter of the UE.

An apparatus for wireless communication is described. The apparatus may include a memory and at least one processor of a network entity, the at least one processor coupled with the memory. The at least one processor may be configured to communicate with a UE that is using a first communication beam, receive a message that indicates a time parameter indicating a time the UE is to switch from the first communication beam to a second communication beam and a predicted change in a communication parameter of the UE associated with switching from the first communication beam to the second communication beam, and change a configuration of the network entity, a configuration of the UE, or both based on the time parameter and the predicted change in the communication parameter of the UE.

Another apparatus for wireless communication at a network entity is described. The apparatus may include means for communicating with a UE that is using a first communication beam, means for receiving a message that indicates a time parameter indicating a time the UE is to switch from the first communication beam to a second communication beam and a predicted change in a communication parameter of the UE associated with switching from the first communication beam to the second communication beam, and means for changing a configuration of the network entity, a configuration of the UE, or both based on the time parameter and the predicted change in the communication parameter of the UE.

A non-transitory computer-readable medium storing code for wireless communication at a network entity is described. The code may include instructions executable by a processor to communicate with a UE that is using a first communication beam, receive a message that indicates a time parameter indicating a time the UE is to switch from the first communication beam to a second communication beam and a predicted change in a communication parameter of the UE associated with switching from the first communication beam to the second communication beam, and change a configuration of the network entity, a configuration of the UE, or both based on the time parameter and the predicted change in the communication parameter of the UE.

Some examples of the method, apparatuses, and non-transitory computer-readable medium described herein may further include operations, features, means, or instructions for receiving, before the time the UE may be to switch to the second communication beam, an indication of a communication beam for the network entity to use after the UE switches to the second communication beam and communicating with the UE using the communication beam after the UE switches to the second communication beam based on the indication of the communication beam.

Some examples of the method, apparatuses, and non-transitory computer-readable medium described herein may further include operations, features, means, or instructions for receiving, before the time the UE may be to switch to the second communication beam, a request for a downlink reference signal for the UE to measure using the second communication beam and receiving channel state information that may be based on the downlink reference signal.

Some examples of the method, apparatuses, and non-transitory computer-readable medium described herein may further include operations, features, means, or instructions for receiving, before the time the UE may be to switch to the second communication beam, a request for the network entity to perform a beam sweep procedure after the UE switches to the second communication beam and performing the beam sweep procedure after the UE switches to the second communication beam and based on the request.

Some examples of the method, apparatuses, and non-transitory computer-readable medium described herein may further include operations, features, means, or instructions for determining, based on the message, a duration of time during which to suspend communication with the UE, the duration of time relative to the time the UE may be to switch to the second communication beam.

In some examples of the method, apparatuses, and non-transitory computer-readable medium described herein, the duration of time may be based on a capability of the UE and a cyclic prefix length.

Some examples of the method, apparatuses, and non-transitory computer-readable medium described herein may further include operations, features, means, or instructions for transmitting a second message to the UE confirming receipt of the message.

In some examples of the method, apparatuses, and non-transitory computer-readable medium described herein, the message may be conveyed in a physical uplink control channel and the second message may be included in downlink control information for the UE.

In some examples of the method, apparatuses, and non-transitory computer-readable medium described herein, the message may be conveyed in a physical uplink shared channel and the second message may be included in an uplink grant that may have a same hybrid automatic repeat request identifier as the physical uplink shared channel.

Some examples of the method, apparatuses, and non-transitory computer-readable medium described herein may further include operations, features, means, or instructions for performing a random access procedure with the UE, where the message may be part of the random access procedure.

### BRIEF DESCRIPTION OF THE DRAWINGS

FIG. 1 illustrates an example of a wireless communications system that supports beam switch prediction and reporting in accordance with one or more aspects of the present disclosure.

FIG. 2 illustrates an example of a wireless communications system that supports beam switch prediction and reporting in accordance with one or more aspects of the present disclosure.

FIG. 3 illustrates an example of a process flow that supports beam switch prediction and reporting in accordance with one or more aspects of the present disclosure.

FIGS. 4 and 5 show block diagrams of devices that support beam switch prediction and reporting in accordance with one or more aspects of the present disclosure.

FIG. 6 shows a block diagram of a communications manager that supports beam switch prediction and reporting in accordance with one or more aspects of the present disclosure.

FIG. 7 shows a diagram of a system including a device that supports beam switch prediction and reporting in accordance with one or more aspects of the present disclosure.

FIGS. 8 and 9 show block diagrams of devices that support beam switch prediction and reporting in accordance with one or more aspects of the present disclosure.

FIG. 10 shows a block diagram of a communications manager that supports beam switch prediction and reporting in accordance with one or more aspects of the present disclosure.

FIG. 11 shows a diagram of a system including a device that supports beam switch prediction and reporting in accordance with one or more aspects of the present disclosure.

FIGS. 12 and 13 show flowcharts illustrating methods that support beam switch prediction and reporting in accordance with one or more aspects of the present disclosure.

### DETAILED DESCRIPTION

In some wireless communications systems, a user equipment (UE) may use beamforming to communicate with another wireless communications device, such as a network entity. For example, a UE may use beamforming to focus a communication beam (e.g., a transmit beam, a receive beam) in a direction that facilitates communication with the network entity. As conditions change, due to, for example, UE movement or the movement of various surrounding obstructions, the UE may switch communication beams to maintain a threshold quality of connectivity with the network entity. But switching communication beams may change one or more communication parameters of the UE that in turn impact one or more configurations set by the network entity.

According to the techniques described herein, a UE may predict an upcoming switch between communication beams (referred to as a beam switch) and report the predicted beam switch, along with any associated changes in communication parameters, to a network entity, which may use the reported information to change one or more configurations. In some examples, the UE may also report the time at which the UE expects to implement the beam switch, which may allow the network entity to select an appropriate time to implement the changes to the one or more configurations.

Aspects of the disclosure are initially described in the context of wireless communications systems. Additional aspects are described with reference to a process flow. Aspects of the disclosure are further illustrated by and described with reference to apparatus diagrams, system diagrams, and flowcharts that relate to beam switch prediction and reporting.

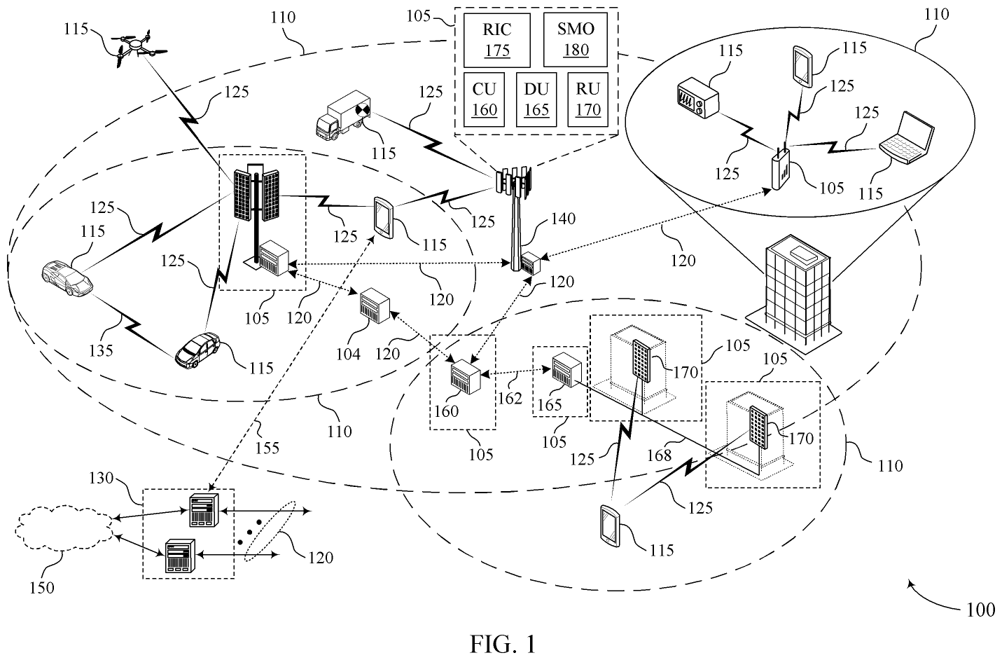

FIG. 1 illustrates an example of a wireless communications system 100 that supports beam switch prediction and reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support beam switch prediction and reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples of the wireless communications system 100, a UE 115 that is using beamforming may predict a future switch between communication beams of the UE 115. For instance, a UE 115 that is using a first communication beam may use movement information (for the UE 115 and or for surrounding obstructions) and information from past communication sessions to predict a second communication beam for use in the future. Upon predicting a switch between communication beams, the UE 115 may predict one or more expected changes in communication parameters associated with the switch. The UE 115 may report a timing for the predicted beam switch, along with the predicted changes in communication parameter(s), to a network entity 105 so that the network entity 105 can react (e.g., update one or more configurations) accordingly.

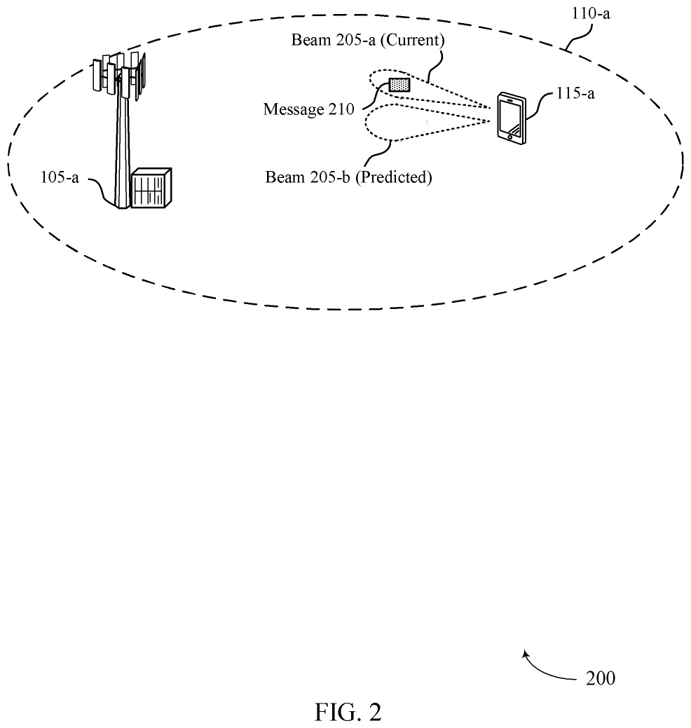

FIG. 2 illustrates an example of a wireless communications system 200 that supports beam switch prediction and reporting in accordance with one or more aspects of the present disclosure. The wireless communications system 200 may implement or be implemented by aspects of the wireless communications system 100 as described with reference to FIG. 1. For example, the wireless communications system 200 may include a network entity 105-a and a UE 115-a which may represent examples of a network entity 105 and a UE 115 as described with reference to FIG. 1. The network entity 105-a may communicate with the UE 115-a within a geographic coverage area 110-a. According to the techniques described herein, the UE 115-a may predict a switch in communication beams and report information related to the beam switch to the network entity 105-a. In some examples, the communication beams referred to herein may be side beams. In some examples, the wireless communications system 200 may be a mmW wireless communication system (e.g., a wireless communication system that supports mmW communications).

The UE 115-a may communicate with the network entity 105-a using a communication beam 205-a, which may be defined by a set of parameters such as beam width and beam direction. The UE 115-a may select the set of parameters for the communication beam 205-a based on communication conditions (e.g., signal strength, noise, interference).

As the UE 115-a operates, the UE 115-a may move in various manners. For instance, the UE 115-a may change locations, rotate (e.g., change orientation), or (if the UE 115-a is a flipping UE, a UE with a flexible display, or both) change physical configuration (e.g., go from an open or unfolded configuration to a closed or folded configuration). Additionally or alternatively, various obstructions (e.g., vehicles) around the UE 115-a may change positions. Such changes may be accompanied by changes in communication conditions, which may render the set of parameters initially selected for the communication beam 205-a less desirable. So, the UE 115-a may switch to the communication beam 205-b, which may have different characteristics (e.g., beam width, directivity) than the communication beam 205-a. The communication beams 205 may be transmit beams, which may also be referred to as uplink beams, or receive beams, which may also be referred to as downlink beams.

But waiting for communication conditions to switch communication beams may increase latency associated with beam adjustments, among other disadvantages. According to the techniques described herein, the UE 115-a may predict use of a new communication beam before communication conditions prompt the UE 115-a to switch to the new communication beam. Switching to a new communication beam may involve activating new antenna panels (relative to those activated for the current communication beam) or modifying the beamforming weights applied to already-activated antenna panels, among other examples.

In some examples, the UE 115-a may use machine learning or artificial intelligence to predict the future use of a communication beam. The prediction may be based on movement of the UE 115-a (e.g., a change in location of the UE 115-a, a change in orientation of the UE 115-a, a change in physical configuration of the UE 115-a), a change in obstruction(s), or any combination thereof, among other examples. The UE 115-a may use signal strength (e.g., reference signal receive power (RSRP)) measurements of synchronization signals or reference signals, directivity gain measurements, sensor measurements (e.g., radio frequency (RF) sensor measurements, inertial measurement unit (IMU) sensor measurements, accelerometer measurements), camera information, or a combination thereof to detect movement (e.g., rotation) of the UE 115-a.

By tracking the movement (e.g., rotation) of the UE 115-a and referencing past communication sessions within similar movement, the UE 115-a may predict a switch from the communication beam 205-a to the communication beam 205-b. In some examples, the UE 115-a may predict a switch between communication beams if the likelihood of switching communication beams is greater than a threshold likelihood. The UE 115-a may predict use of the communication beam 205-b, even if the movement (e.g., rotation) of the UE 115-a is different than past movement and even without information on movement from a sensor, based on RSRP measurements (e.g., based on degradation of directivity gain).

Upon predicting an upcoming switch to the communication beam 205-b, the UE 115-a may predict changes in one or more communication parameters or configurations of the UE 115-a. For instance, the UE 115-a may determine a change (e.g., decrease, increase) in MIMO rank, a change (e.g., decrease, increase) in directivity gain, a change in power headroom, a change in transmission configuration indicator (TCI) state, or a combination thereof, among other examples. In some examples, the changes in communication parameters may arise from changing antenna panels to form the communication beam 205-b, and thus may correspond to the beam switch time.

Changes in communication parameters that arise from switching communication beams may impact one or more configurations set by the network entity 105-a. To help the network entity 105-a account for changes in communication parameters in a timely manner (e.g., close in time to the beam switch), the UE 115-a may indicate the changes in the message 210.

The UE 115-a transmit the message 210 after predicting the switch to the communication beam 205-b but before switching to the communication beam 205-b. In addition to indicating the changes in communication parameters, the message 210 may include a time parameter (which may be referred to as a time stamp) that indicates a time at which the UE 115-a is to switch from the communication beam 205-a to the communication beam 205-b (which may be referred to as the beam switch time). Thus, the time parameter may indicate the time after which the changes in communication parameters will occur. The information in the message 210 may allow the network entity 105-a to update one or more configurations in parallel with (e.g., concurrently), or in advance of, the UE 115-a switching to the communication beam 205-b.

Upon receipt of the message 210, the network entity 105-a may change one or more configurations of the network entity 105-a, one or more configurations of the UE 115-a, or of both. For example, the network entity 105-a may change the MIMO rank associated with an upcoming transmission for the UE 115-a if the message 210 indicates a new MIMO rank of the UE 115-a that is associated with the communication beam 205-b. In another example, the network entity 105-a may set and indicate a new configuration for a periodic or persistent transmission, such as periodic SRS or configured grant (CG) physical uplink shared channel (PUSCH), based on the new MIMO rank of the UE 115-a. In another example, the network entity 105-a may change the modulation and coding scheme (MCS) for communicating with the UE 115-a if the message 210 indicates a change in directivity gain. In another example, the network entity 105-a may change the MCS, one or more power control parameters, or both, for uplink communications by the UE 115-a if the message 210 indicates a new power headroom associated with the communication beam 205-b. Other examples of configuration changes are contemplated and within the scope of the present disclosure.

In some examples, the network entity 105-a may determine a duration of time (which may be referred to as a beam switch gap) during which to suspend communications with the UE 115-a so that the UE 115-a can switch communication beams without dropping content. The beam switch gap may be relative to the beam switch time (the time the switch between communication beams is to occur) and may be based on a capability of the UE 115-a (e.g., a beam switching capability, which may be communicated by the 115-a) and a cyclic prefix length. For example, the network entity 105-a may determine to implement a beam switch gap if the time it takes the UE 115-a to switch between communication beams (as indicated by the beam switching capability) is greater than the cyclic prefix length. In such a scenario (which may occur in mmW communication systems), the network entity 105-a may determine the duration of the beam switch gap based on the beam switching capability of the UE 115-a.

In some examples, the network entity 105-a may schedule the beam switch gap by indicating the beam switch gap to the UE 115-a. In other examples, the network entity 105-a and the UE 115-a may autonomously implement a beam switch gap. For instance, the network entity 105-a may implement the beam switch gap based on receiving the message 210 and the UE 115-a may autonomously implement the beam switch gap based on transmitting the message 210 or based on receiving a message from the network entity 105-a confirming receipt of the message 210. In such a scenario, the beam switch gap may be configured at network entity 105-a and the UE 115-a before the UE 115-a transmits the message 210.

In some examples, the UE 115-a may indicate to the network entity 105-a a preferred communication beam for the network entity 105-a to use after the UE 115-a switches to the communication beam 205-b. The preferred communication beam may be based on the communication beam 205-b and may be indicated in the message 210 or in a separate message. The network entity 105-a may switch to the preferred communication beam based on the time parameter. For example, the network entity 105-a may switch to the preferred communication beam at substantially the same time the UE 115-a switches to the communication beam 205-b or a threshold amount of time before or after.

After predicting the switch to the communication beam 205-b (but possibly before switching to the communication beam 205-b) the UE 115-a may request one or more reference signals or uplink resources from the network entity 105-a. For example, the UE 115-a may request a set of reference signal resources (e.g., a set of sounding reference signal (SRS) resources) within which the UE 115-a can transmit an SRS (e.g., a codebook-based SRS or a non-codebook-based SRS) for the network entity 105-a to use for uplink channel estimation. In such an example, the network entity 105-a may schedule reference signal resources for the UE 115-a based on the beam switch time (e.g., the network entity 105-a may schedule the UE 115-a with reference signal resources that occur after the UE 115-a switches to communication beam 205-b).

In another example, the UE 115-a may request the network entity 105-a transmit a reference signal (e.g., a channel state information reference signal (CSI-RS)) that the UE 115-a can use for downlink channel estimation (e.g., by using the communication beam 205-b to measure the CSI-RS). After determining channel state information based on the CSI-RS, the UE 115-a may transmit the channel state information (e.g., precoding matrix indicator (PMI), rank indicator (RI), channel quality indicator (CQI)) associated with the communication beam 205-b to the network entity 105-a. In such an example, the network entity 105-a may transmit the reference signal to the UE 115-a based on the beam switch time (e.g., the network entity 105-a may transmit the reference signal to the UE 115-a after the UE 115-a switches to communication beam 205-b). The UE 115-a may transmit the associated channel state information in resources already scheduled by the network entity 105-a or in resource requested by the UE 115-a after predicting the switch to the communication beam 205-b (but possibly before switching to the communication beam 205-b).

After predicting the switch to the communication beam 205-b (but possibly before switching to the communication beam 205-b) the UE 115-a may request that the network entity 105-a perform a beam sweep procedure. For example, the UE 115-a may request that the network entity 105-a perform a P3 beam sweep procedure in which the network entity 105-a repeatedly transmits over the same transmit beam so that the UE 115-a can calibrate, refine, and confirm the communication beam 205-b. Additionally or alternatively, the UE 115-a may perform a beam sweep procedure after switching to the communication beam 205-b so that the UE 115-a can calibrate, refine, and confirm the communication beam 205-b.

The requests by the UE 115-a may be transmitted using the communication beam 205-a or the communication beam 205-b and may be included in the message 210 or a different message. As noted, the requests by the UE 115-a may correspond to the beam switch time in that the requests may indicate a timing for the requests that is based on the beam switch time.

Thus, the UE 115-a may facilitate timely configuration updates by predicting a switch in communication beams and reporting information related to the beam switch to the network entity 105-a. Although described with reference to a communication beam, the techniques described herein may be implemented for any quantity of communication beams, including multiple communication beams.

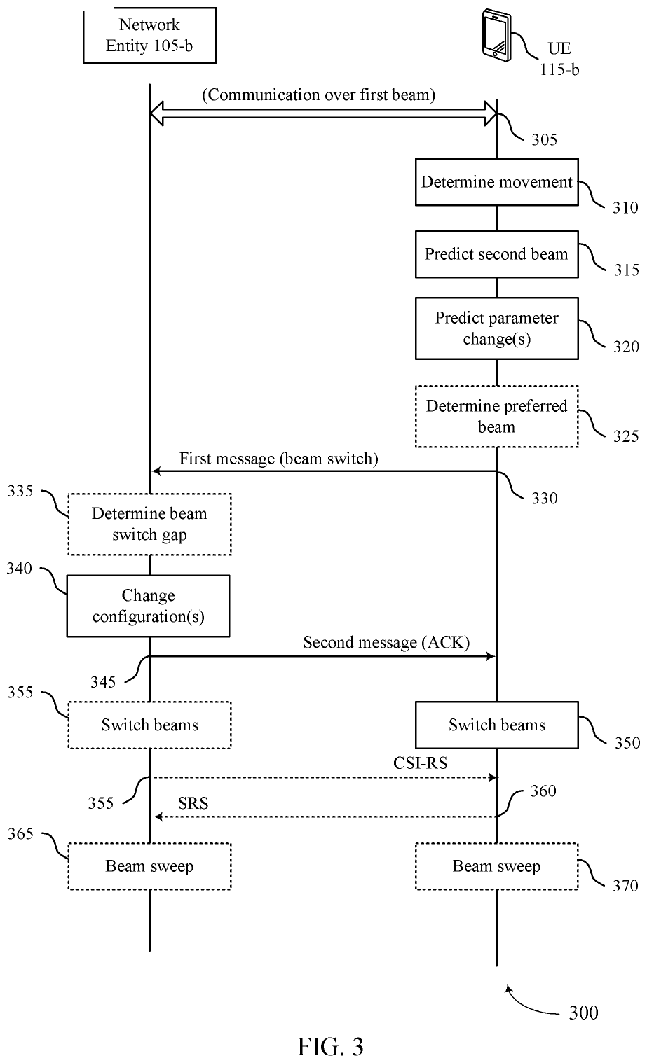

FIG. 3 illustrates an example of a process flow 300 that supports beam switch prediction and reporting in accordance with one or more aspects of the present disclosure. The process flow 300 may be implemented by aspects of the wireless communications systems 100 and 200 as described with reference to FIGS. 1 and 2. For example, the process flow 300 may be implemented by a network entity 105-b and a UE 115-b, which may be examples of a network entity and a UE as described with reference to FIGS. 1 and 2. By implementing the process flow 300, the UE 115-b may facilitate beam management in a scenario in which the UE 115-b switches communication beams.

In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless devices.

At 305, the UE 115-b may communicate with the network entity 105-b using a first communication beam. At 310, the UE 115-b may determine movement of the UE 115-b, may determine movement of a nearby obstruction, or both. For example, the UE 115-a may determine that the UE 115-b is changing location (e.g., changing latitude, longitude, altitude), changing orientation (e.g., rotating), changing physical configuration (e.g., folding or unfolding), or any combination thereof. Additionally or alternatively, the UE 115-b may determine movement of one or more surrounding obstructions. The UE 115-b may determine the movement at 310 based on sensor information, camera information, synchronization signal measurements (e.g., synchronization signal block (SSB) measurements), reference signal measurements (e.g., CSI-RS measurements), or any combination thereof, among other examples.

At 315, the UE 115-b may use machine learning or artificial intelligence, or some other mechanism, to predict a second communication beam for use based on the movement determined at 310. At 320, the UE 115-b may predict a change in one or more communication parameters associated with switching to the second communication beam. For example, the UE 115-b may predict a change in rank (e.g., MIMO rank), a change in directivity gain (e.g., receive directivity gain), a change in power headroom, a change in TCI state, or any combination thereof, among other examples.

At 325, the UE 115-b may determine a preferred communication beam for use by the network entity 105-b after the UE 115-b switches to the second communication beam. The UE 115-b may determine the preferred communication beam based on the second communication beam.

At 330, the UE 115-b may transmit a first message to the network entity 105-b. The first message may indicate the changes to the one or more communication parameters, a time parameter that indicates a time for the UE 115-b to switch to the second communication beam (e.g., the beam switch time), or both. Additionally or alternatively, the first message may indicate the preferred communication beam determined at 325. If the UE 115-a requests uplink resources, reference signals, or a beam sweep procedure, the requests may be included in the first message, included in a separate message, or split between the first message and the separate message.

The first message may be included in uplink control information (UCI) that is conveyed by an uplink control channel (e.g., the physical uplink control channel (PUCCH)) or an uplink data channel (e.g., the PUSCH). In such a scenario, the uplink resources for the UCI may be configured in advance or the UCI can be carried in uplink resources from an existing uplink grant. Alternatively, the first message may be included in a medium access control (MAC) control element (MAC-CE). In such a scenario, the MAC-CE can be carried in uplink resources for an existing uplink grant or in uplink resources that are requested by the UE 115-b via a scheduling request (SR). The scheduling request may be a beam switch-specific scheduling request or a non-beam switch-specific scheduling request. If scheduling requests are not supported or configured, or in other examples, the UE 115-b may initiate a random access procedure (e.g., a random access channel (RACH) procedure) and use one of the random access messages to convey the first message. For example, the first message may be included in MsgA of a two-step RACH procedure or may be included in Msg3 of a four-step RACH procedure. Put another way, the first message may be part of the random access procedure.

The first message may be transmitted according to a periodicity (e.g., if beam switch messages are configured to occur periodically). For example, the first message may be included in a persistent or semi-persistent PUCCH. Additionally or alternatively, the first message may be transmitted in response to a trigger, such as satisfaction of a condition. For example, the UE 115-b may transmit the first message if the UE 115-b determines that continued use of the first communication beam is associated with a first predicted signal strength that is lower than a second predicted signal strength associated with use of the second communication beam. As an illustration, the UE 115-b may transmit the first message if the UE 115-b determines that continued use of the first communication beam is associated with −X dB gain relative to use of the second communication beam.

In some examples, the UE 115-b may transmit the first message if one or more timing conditions are satisfied. In one example, there may be a limit on the frequency at which the UE 115-b is permitted to transmit beam switch messages. For instance, the UE 115-b may track (e.g., via a timer) the duration of time that has elapsed since the UE 115-b sent a previous beam switch message and, if the duration of time is greater than a threshold duration of time, the UE 115-b may transmit the first message. If the duration of time that has elapsed is less than the threshold duration of time, the UE 115-b may delay transmission of the first message until after the threshold duration of time has elapsed.

In another example of a timing condition, the UE 115-b may refrain from transmitting the first message too far in advance of the beam switch time (e.g., the time at which the beam switch is to occur). For instance, the UE 115-b may wait to transmit the first message until there is less than a threshold duration of time (e.g., Y ms) between A) transmission of the first message and B) the beam switch time. In a similar example, the UE 115-b may transmit the first message if the duration of time between A) prediction of the beam switch and B) the beam switch time is less than a threshold duration of time. By placing a limit on how early (relative to the beam switch time) the UE 115-b can transmit a beam switch message, the UE 115-b may reduce the likelihood that the beam switch prediction is negated by changing conditions.

In another example of a timing condition, the UE 115-b may refrain from transmitting the first message too close in time to the beam switch time. For instance, the UE 115-b may refrain from transmitting the first message if there is less than a threshold duration of time (e.g., X ms, where X is less than Y) between A) transmission of the first message and B) the beam switch time. Put another way, the UE 115-b may transmit the first message if the duration of time between A) transmission of the first message and B) the beam switch time is greater than the threshold duration of time (e.g., X ms). By placing a limit on how late (relative to the beam switch time) the UE 115-b can transmit a beam switch message, the UE 115-b may reduce the likelihood that the network entity 105-b in unable to process the beam switch message before the beam switch time. In some examples, the UE 115-b may use the timing conditions described herein to define a window of time during which transmission of the first message is permitted.

The condition(s) for transmitting the first message may be specific to the UE 115-b or may be configured by the network entity 105-b.

At 335, the network entity 105-b, may determine a beam switch gap based on the first message (e.g., the network entity 105-b may determine a duration of time during which communications are suspended). The timing of the beam switch gap may be based on with the time parameter that indicates the beam switch time, and the duration of the beam switch gap may be based on a beam switching capability of the UE 115-b, the cyclic prefix length for communicating with the UE 115-b, or both. In some examples, the network entity 105-b may indicate the beam switch gap to the UE 115-b. In other examples, the beam switch gap may be autonomously determined by the UE 115-b.

At 340, the network entity 105-b may change one or more configurations of the network entity 105-b, may change one or more configurations of the UE 115-b, or both. For example, the network entity 105-b may change the MIMO rank for communications with the UE 115-b, or schedule new transmissions, based on the MIMO rank indicated in the first message. In another example, the network entity 105-b may use the new MIMO rank of the UE 115-b as a basis for a new configuration for a periodic or persistent transmission, such as periodic SRS or configured grant PUSCH. In another example, the network entity 105-b may use the new directivity gain of the UE 115-b as a basis for changing the MCS for communicating with the UE 115-b. In another example, the network entity 105-b may use the new power headroom of the UE 115-b as a basis for changing the MCS, one or more power control parameters, or both, for communications by (or with) the UE 115-b.

Although shown occurring before 345, one or more of the operations at 340 may occur concurrently with, or after 345. In some examples, changing a configuration may include transmitting an indication of the changed configuration to the UE 115-b.

At 345, the network entity 105-b may transmit a second message confirming (e.g., acknowledging) receipt of the first message at 330. In some examples, the second message (which may be referred to as an acknowledgment) may be included in downlink control information (DCI) for the UE 115-b. For example, if the first message is included in the PUCCH, the second message may be included in DCI. If the first message indicates a change in TCI state, the second message may be included in DCI that is for switching TCI to the reported beam. In some examples, the second message may be included in a physical uplink data channel (e.g., the PUSCH). For example, if the first message is included in the PUSCH (e.g., in UCI or a MAC-CE), the second message may be a new uplink grant that has the same HARQ identifier as the PUSCH.

At 350, the UE 115-b may switch from the first communication beam to the second communication beam. The UE 115-b may switch to the second communication beam at the beam switch time indicated by the time parameter in first message. In some examples, the UE 115-b may switch to the second communication beam based on receiving the second message from the network entity 105-b.

In some examples, the network entity 105-b may, at 355, switch to the preferred communication beam indicated by the first message. The timing for switching to the preferred communication beam may be based on the beam switch time indicated in the first message. For example, the network entity 105-b may switch to the preferred communication beam at the same time as the beam switch time or within a threshold duration of time before or after the beam switch time.

In some examples (e.g., if the first message or a separate message requests a downlink reference signal, such as CSI-RS), the network entity 105-b may transmit one or more reference signals (e.g., CSI-RS) at 355. The network entity 105-b may transmit the one or more reference signals after the beam switch time (e.g., after 350) so that the UE 115-b can use the second communication beam to measure the reference signal(s) for downlink channel estimation. The transmission timing for the reference signal(s) may be requested by the UE 115-b or may be determined by the network entity 105-b based on the beam switch time indicated by the time parameter. After measuring the reference signal(s) using the second communication beam, the UE 115-b may transmit a report indicating channel state information that is based on the measurements.

In some examples (e.g., if the first message or a separate message requests uplink resources), the network entity 105-b may schedule the UE 115-b with uplink resources so that the UE 115-b can transmit an uplink reference signal (e.g., SRS) using the second communication beam at 360. The timing of the uplink resources may be requested by the UE 115-b or may be determined by the network entity 105-b based on the beam switch time indicated by the time parameter. The network entity 105-b may measure the SRS in the uplink resources to estimate the uplink channel between the UE 115-b and the network entity 105-b.

In some examples (e.g., if the first message or a separate message requests a beam sweep procedure), the network entity 105-b may perform a beam sweep procedure (e.g., a P3 beam sweep procedure) at 365 so that the UE 115-b can characterize the second communication beam. The timing of the beam sweep procedure may be requested by the UE 115-b or may be determined by the network entity 105-b based on the beam switch time indicated by the time parameter. Additionally or alternatively, the UE 115-b may characterize the second communication beam by performing a beam sweep procedure using the second communication beam at 370.

Thus, the UE 115-b may facilitate beam management in a scenario in which the UE 115-b switches communication beams.

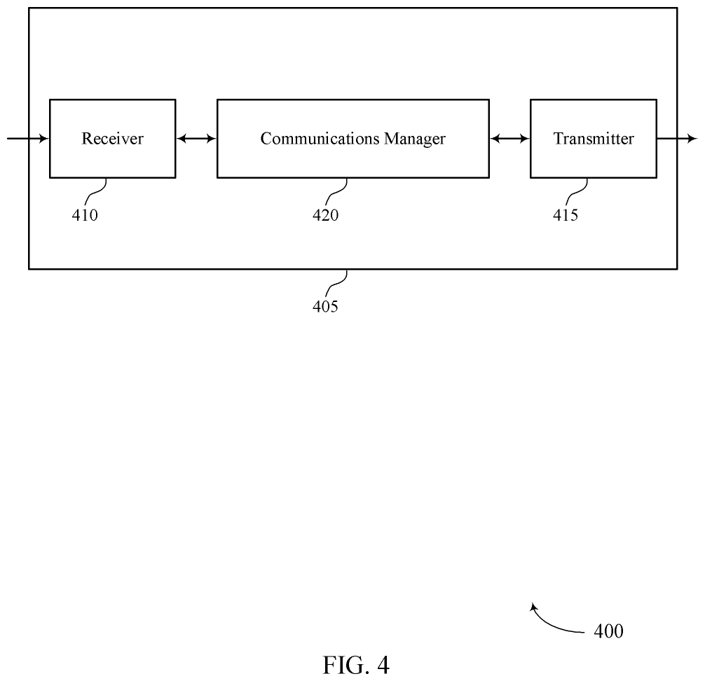

FIG. 4 shows a block diagram 400 of a device 405 that supports beam switch prediction and reporting in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to beam switch prediction and reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to beam switch prediction and reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of beam switch prediction and reporting as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for communicating, with a network entity, using a first communication beam. The communications manager 420 may be configured as or otherwise support a means for determining a second communication beam to use for communicating with the network entity after using the first communication beam. The communications manager 420 may be configured as or otherwise support a means for predicting a change in a communication parameter of the UE associated with switching from the first communication beam to the second communication beam. The communications manager 420 may be configured as or otherwise support a means for transmitting, to the network entity before switching to the second communication beam, a message that indicates the predicted change in the communication parameter and a time parameter, the time parameter indicating a time to switch to the second communication beam.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced latency associated with beam switching.

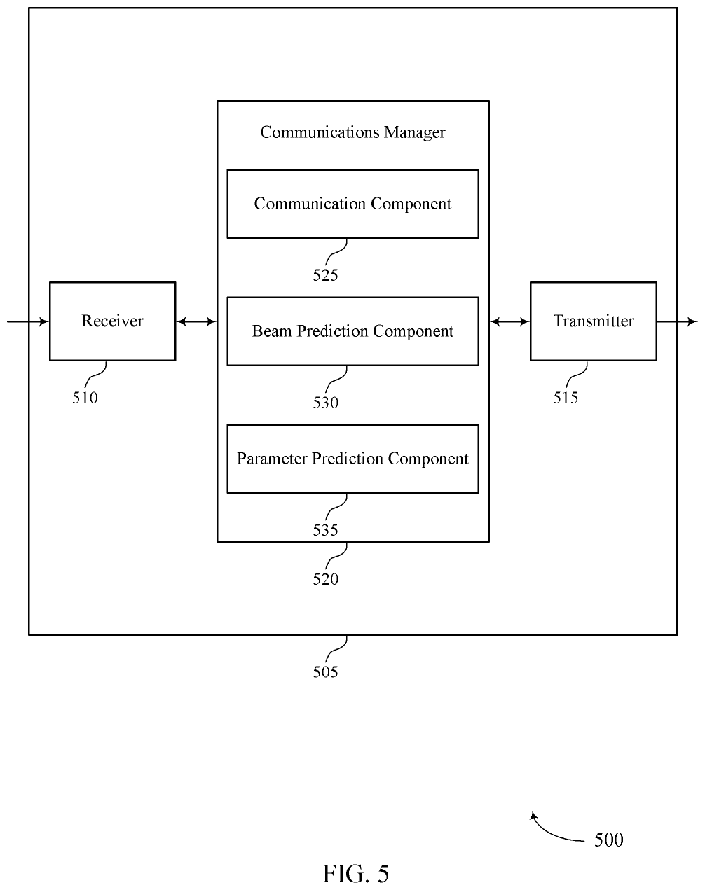

FIG. 5 shows a block diagram 500 of a device 505 that supports beam switch prediction and reporting in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to beam switch prediction and reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to beam switch prediction and reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of beam switch prediction and reporting as described herein. For example, the communications manager 520 may include a communication component 525, a beam prediction component 530, a parameter prediction component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The communication component 525 may be configured as or otherwise support a means for communicating, with a network entity, using a first communication beam. The beam prediction component 530 may be configured as or otherwise support a means for determining a second communication beam to use for communicating with the network entity after using the first communication beam. The parameter prediction component 535 may be configured as or otherwise support a means for predicting a change in a communication parameter of the UE associated with switching from the first communication beam to the second communication beam. The communication component 525 may be configured as or otherwise support a means for transmitting, to the network entity before switching to the second communication beam, a message that indicates the predicted change in the communication parameter and a time parameter, the time parameter indicating a time to switch to the second communication beam.

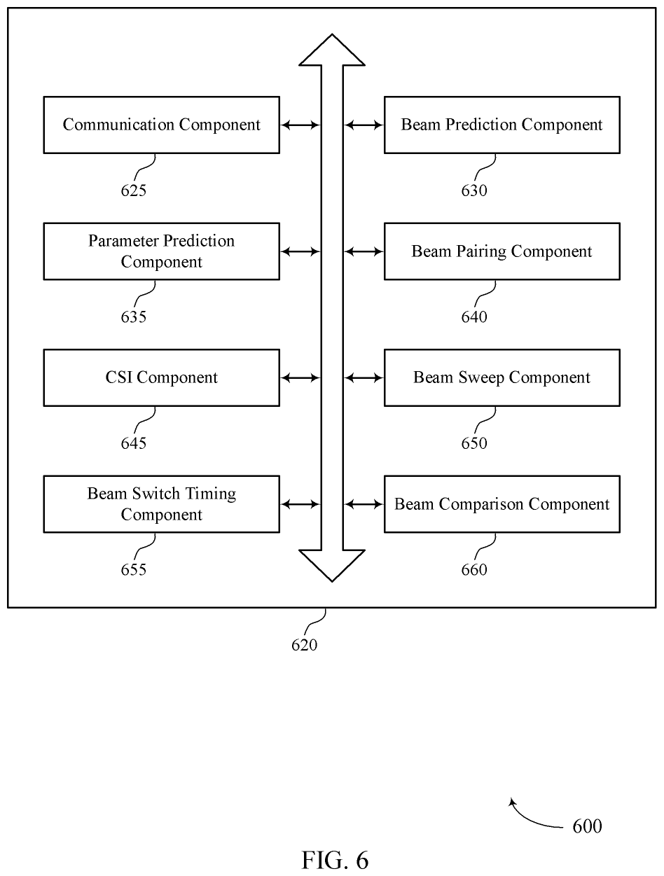

FIG. 6 shows a block diagram 600 of a communications manager 620 that supports beam switch prediction and reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of beam switch prediction and reporting as described herein. For example, the communications manager 620 may include a communication component 625, a beam prediction component 630, a parameter prediction component 635, a beam pairing component 640, a CSI component 645, a beam sweep component 650, a beam switch timing component 655, a beam comparison component 660, or any combination thereof. Each of these components may communicate, directly or indirectly, with one another (e.g., via one or more buses).

The communications manager 620 may support wireless communication at a UE in accordance with examples as disclosed herein. The communication component 625 may be configured as or otherwise support a means for communicating, with a network entity, using a first communication beam. The beam prediction component 630 may be configured as or otherwise support a means for determining a second communication beam to use for communicating with the network entity after using the first communication beam. The parameter prediction component 635 may be configured as or otherwise support a means for predicting a change in a communication parameter of the UE associated with switching from the first communication beam to the second communication beam. In some examples, the communication component 625 may be configured as or otherwise support a means for transmitting, to the network entity before switching to the second communication beam, a message that indicates the predicted change in the communication parameter and a time parameter, the time parameter indicating a time to switch to the second communication beam.

In some examples, the beam pairing component 640 may be configured as or otherwise support a means for determining a communication beam for the network entity based on the second communication beam. In some examples, the communication component 625 may be configured as or otherwise support a means for indicating the communication beam for the network entity before switching from the first communication beam to the second communication beam.

In some examples, the communication component 625 may be configured as or otherwise support a means for requesting, before switching to the second communication beam, a set of uplink reference signal resources for transmitting an uplink reference signal using the second communication beam.

In some examples, the communication component 625 may be configured as or otherwise support a means for requesting, before switching to the second communication beam, a downlink reference signal to measure using the second communication beam. In some examples, the CSI component 645 may be configured as or otherwise support a means for transmitting channel state information that is based on measuring the downlink reference signal using the second communication beam.

In some examples, the beam sweep component 650 may be configured as or otherwise support a means for requesting, before switching to the second communication beam, the network entity perform a beam sweep procedure after the time to switch to the second communication beam.

In some examples, the beam switch timing component 655 may be configured as or otherwise support a means for determining, based on transmitting the message, a duration of time during which communication with the network entity is suspended, the duration of time relative to the time to switch to the second communication beam.

In some examples, the second communication beam is determined using machine learning, and the beam prediction component 630 may be configured as or otherwise support a means for determining a change in location of the UE, a change in orientation of the UE, a change in a physical configuration of the UE, a change in a surrounding obstruction, or any combination thereof, where the second communication beam is determined based on the change in location of the UE, the change in orientation of the UE, the change in a physical configuration of the UE, the change in the surrounding obstruction, or any combination thereof.

In some examples, the change in the communication parameter includes a change in multiple-input multiple-output rank or a change in directivity gain. In some examples, the message is transmitted according to a periodicity.

In some examples, the beam switch timing component 655 may be configured as or otherwise support a means for determining that a threshold duration of time has elapsed since transmission of a previous message indicating a switch between communication beams, where the message is transmitted based on determining that the threshold duration of time has elapsed.

In some examples, the beam comparison component 660 may be configured as or otherwise support a means for determining that continued use of the first communication beam is associated with a first predicted signal strength that is lower than a second predicted signal strength associated with use of the second communication beam, where the message is transmitted based on the determination that the first predicted signal strength is lower than the second predicted signal strength.

In some examples, the beam switch timing component 655 may be configured as or otherwise support a means for determining that a duration of time between transmission of the message and the time to switch is less than a threshold duration of time, where the message is transmitted based on the determination that the duration of time is less than the threshold duration of time.

In some examples, the beam switch timing component 655 may be configured as or otherwise support a means for determining that a duration of time between transmission of the message and the time to switch is greater than a threshold duration of time, where the message is transmitted based on the determination that the duration of time is greater than the threshold duration of time.

In some examples, the communication component 625 may be configured as or otherwise support a means for receiving a second message confirming receipt of the message by the network entity. In some examples, the communication component 625 may be configured as or otherwise support a means for switching to the second communication beam at the time and based on receiving the second message.

In some examples, the message is conveyed in a physical uplink control channel. In some examples, the second message is included in downlink control information for the UE.

In some examples, the message is conveyed in a physical uplink shared channel. In some examples, the second message is included in an uplink grant that has a same hybrid automatic repeat request identifier as the physical uplink shared channel.

In some examples, the message is included in uplink control information or in a medium access control (MAC) control element.

In some examples, the communication component 625 may be configured as or otherwise support a means for initiating a random access procedure, where the message is part of the random access procedure.

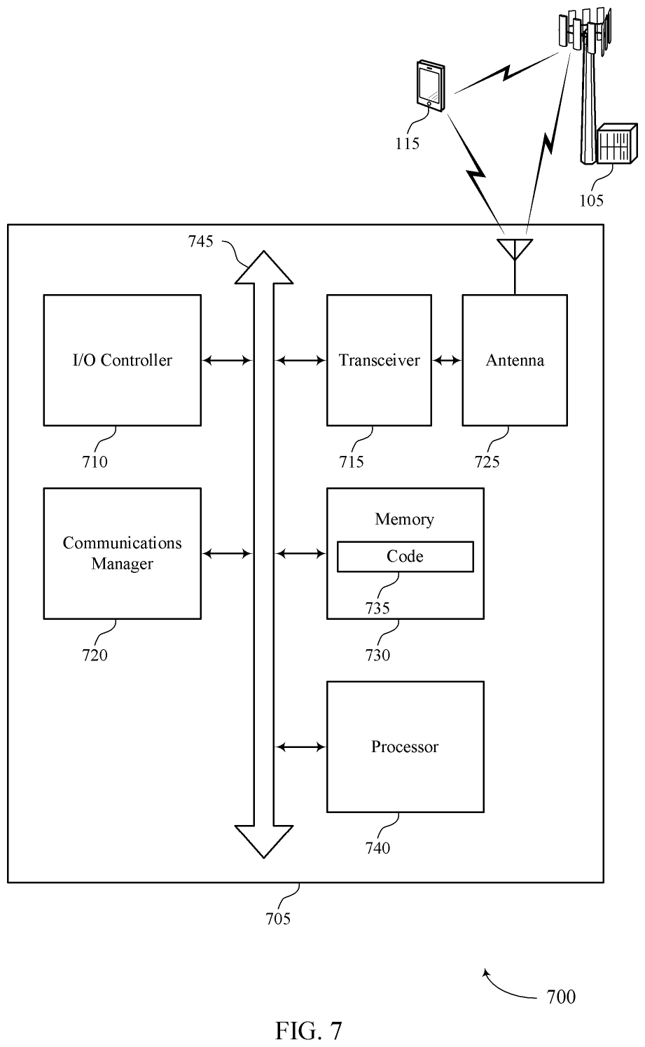

FIG. 7 shows a diagram of a system 700 including a device 705 that supports beam switch prediction and reporting in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting beam switch prediction and reporting). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for communicating, with a network entity, using a first communication beam. The communications manager 720 may be configured as or otherwise support a means for determining a second communication beam to use for communicating with the network entity after using the first communication beam. The communications manager 720 may be configured as or otherwise support a means for predicting a change in a communication parameter of the UE associated with switching from the first communication beam to the second communication beam. The communications manager 720 may be configured as or otherwise support a means for transmitting, to the network entity before switching to the second communication beam, a message that indicates the predicted change in the communication parameter and a time parameter, the time parameter indicating a time to switch to the second communication beam.

By including or configuring the communications manager 720 in accordance with examples as described herein, the device 705 may support techniques for improved communication reliability, reduced latency, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 720 may be configured to receive or transmit messages or other signaling as described herein via the transceiver 715. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of beam switch prediction and reporting as described herein, or the processor 740 and the memory 730 may be otherwise configured to perform or support such operations.

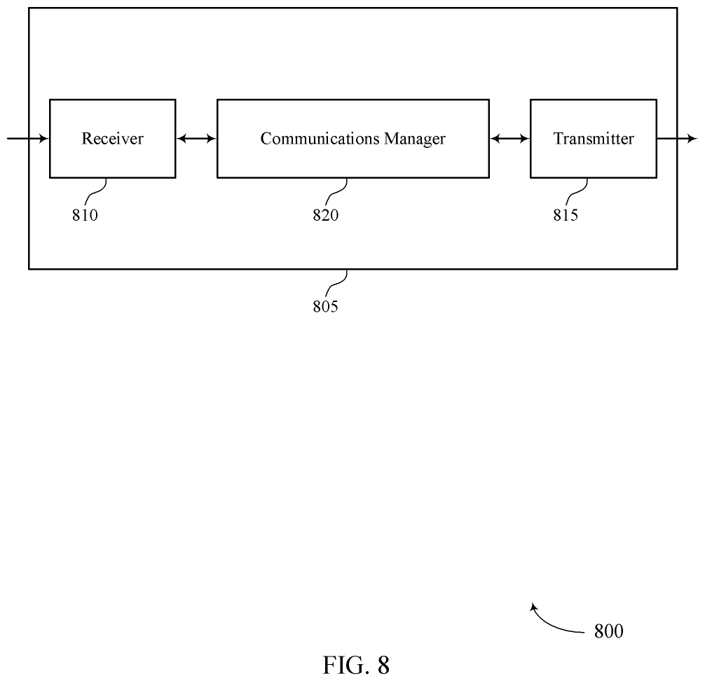

FIG. 8 shows a block diagram 800 of a device 805 that supports beam switch prediction and reporting in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of beam switch prediction and reporting as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for communicating with a UE that is using a first communication beam. The communications manager 820 may be configured as or otherwise support a means for receiving a message that indicates a time parameter indicating a time the UE is to switch from the first communication beam to a second communication beam and a predicted change in a communication parameter of the UE associated with switching from the first communication beam to the second communication beam. The communications manager 820 may be configured as or otherwise support a means for changing a configuration of the network entity, a configuration of the UE, or both based on the time parameter and the predicted change in the communication parameter of the UE.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced latency associated with beam switching.

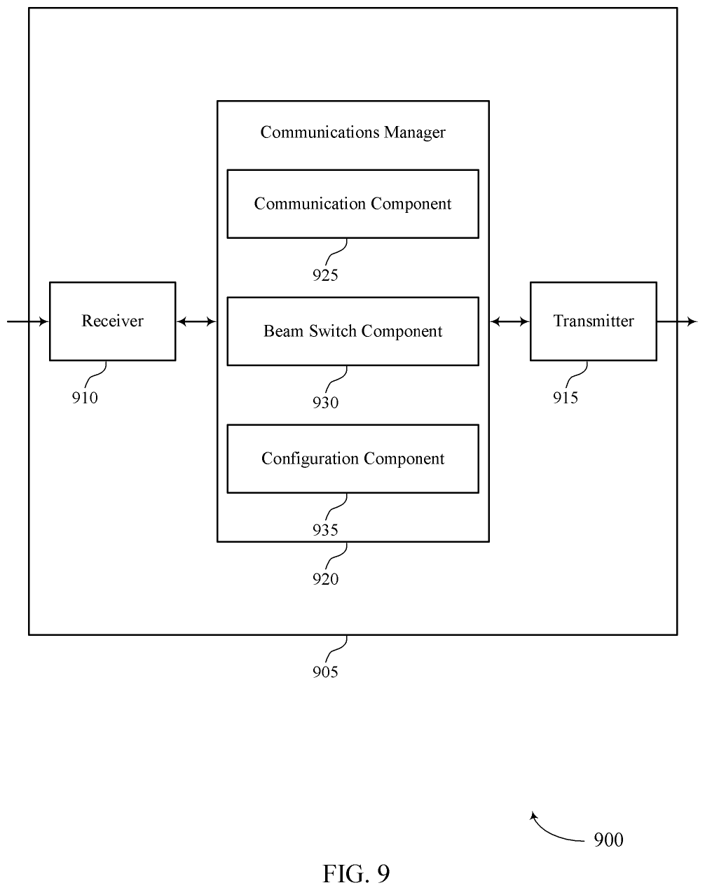

FIG. 9 shows a block diagram 900 of a device 905 that supports beam switch prediction and reporting in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of beam switch prediction and reporting as described herein. For example, the communications manager 920 may include a communication component 925, a beam switch component 930, a configuration component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The communication component 925 may be configured as or otherwise support a means for communicating with a UE that is using a first communication beam. The beam switch component 930 may be configured as or otherwise support a means for receiving a message that indicates a time parameter indicating a time the UE is to switch from the first communication beam to a second communication beam and a predicted change in a communication parameter of the UE associated with switching from the first communication beam to the second communication beam. The configuration component 935 may be configured as or otherwise support a means for changing a configuration of the network entity, a configuration of the UE, or both based on the time parameter and the predicted change in the communication parameter of the UE.

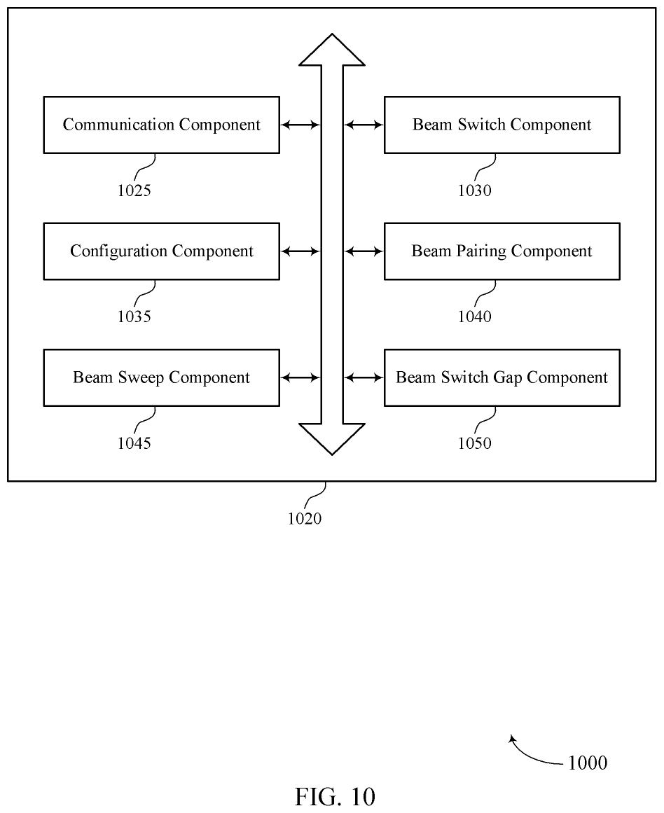

FIG. 10 shows a block diagram 1000 of a communications manager 1020 that supports beam switch prediction and reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of beam switch prediction and reporting as described herein. For example, the communications manager 1020 may include a communication component 1025, a beam switch component 1030, a configuration component 1035, a beam pairing component 1040, a beam sweep component 1045, a beam switch gap component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The communication component 1025 may be configured as or otherwise support a means for communicating with a UE that is using a first communication beam. The beam switch component 1030 may be configured as or otherwise support a means for receiving a message that indicates a time parameter indicating a time the UE is to switch from the first communication beam to a second communication beam and a predicted change in a communication parameter of the UE associated with switching from the first communication beam to the second communication beam. The configuration component 1035 may be configured as or otherwise support a means for changing a configuration of the network entity, a configuration of the UE, or both based on the time parameter and the predicted change in the communication parameter of the UE.

In some examples, the beam pairing component 1040 may be configured as or otherwise support a means for receiving, before the time the UE is to switch to the second communication beam, an indication of a communication beam for the network entity to use after the UE switches to the second communication beam. In some examples, the communication component 1025 may be configured as or otherwise support a means for communicating with the UE using the communication beam after the UE switches to the second communication beam based on the indication of the communication beam.

In some examples, the communication component 1025 may be configured as or otherwise support a means for receiving, before the time the UE is to switch to the second communication beam, a request for a downlink reference signal for the UE to measure using the second communication beam. In some examples, the communication component 1025 may be configured as or otherwise support a means for receiving channel state information that is based on the downlink reference signal.

In some examples, the beam sweep component 1045 may be configured as or otherwise support a means for receiving, before the time the UE is to switch to the second communication beam, a request for the network entity to perform a beam sweep procedure after the UE switches to the second communication beam. In some examples, the beam sweep component 1045 may be configured as or otherwise support a means for performing the beam sweep procedure after the UE switches to the second communication beam and based on the request.

In some examples, the beam switch gap component 1050 may be configured as or otherwise support a means for determining, based on the message, a duration of time during which to suspend communication with the UE, the duration of time relative to the time the UE is to switch to the second communication beam.

In some examples, the duration of time is based on a capability of the UE and a cyclic prefix length. In some examples, the communication component 1025 may be configured as or otherwise support a means for transmitting a second message to the UE confirming receipt of the message.

In some examples, the message is conveyed in a physical uplink control channel. In some examples, the second message is included in downlink control information for the UE.

In some examples, the message is conveyed in a physical uplink shared channel. In some examples, the second message is included in an uplink grant that has a same hybrid automatic repeat request identifier as the physical uplink shared channel.

In some examples, the communication component 1025 may be configured as or otherwise support a means for performing a random access procedure with the UE, where the message is part of the random access procedure.

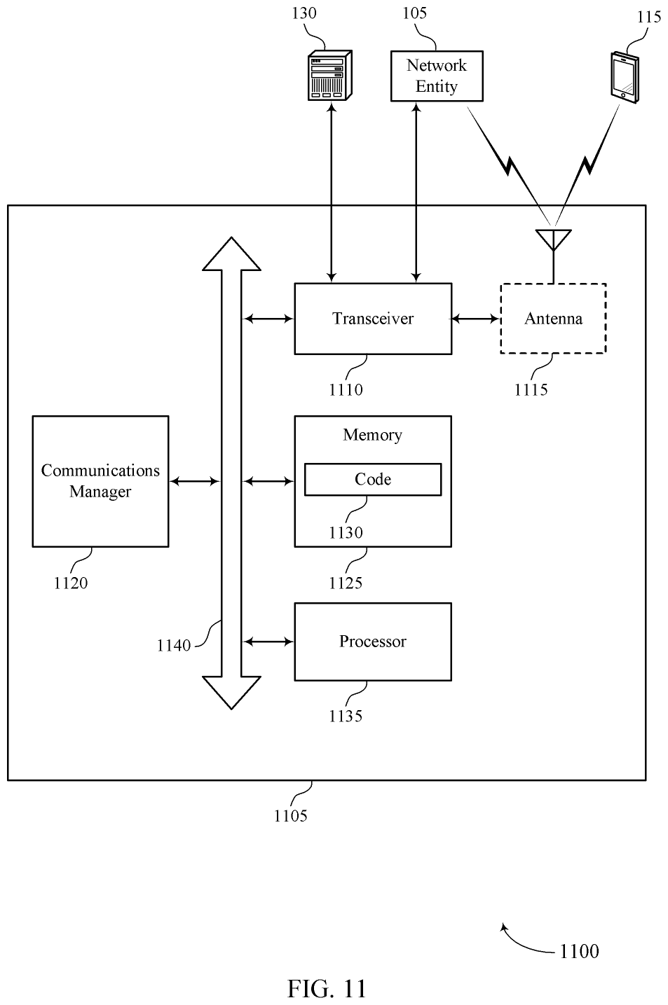

FIG. 11 shows a diagram of a system 1100 including a device 1105 that supports beam switch prediction and reporting in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting beam switch prediction and reporting). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for communicating with a UE that is using a first communication beam. The communications manager 1120 may be configured as or otherwise support a means for receiving a message that indicates a time parameter indicating a time the UE is to switch from the first communication beam to a second communication beam and a predicted change in a communication parameter of the UE associated with switching from the first communication beam to the second communication beam. The communications manager 1120 may be configured as or otherwise support a means for changing a configuration of the network entity, a configuration of the UE, or both based on the time parameter and the predicted change in the communication parameter of the UE.

By including or configuring the communications manager 1120 in accordance with examples as described herein, the device 1105 may support techniques improved communication reliability, reduced latency, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. For example, the communications manager 1120 may be configured to receive or transmit messages or other signaling as described herein via the transceiver 1110. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of beam switch prediction and reporting as described herein, or the processor 1135 and the memory 1125 may be otherwise configured to perform or support such operations.

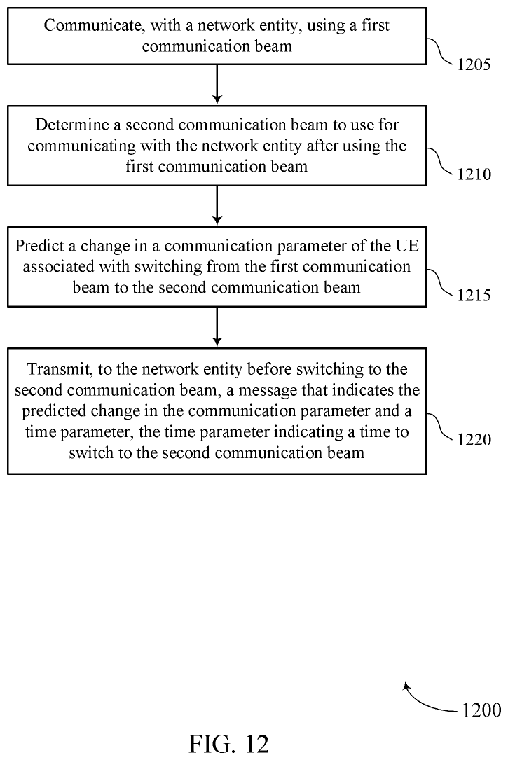

FIG. 12 shows a flowchart illustrating a method 1200 that supports beam switch prediction and reporting in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include communicating, with a network entity, using a first communication beam. The operations of 1205 may be performed in accordance with examples as disclosed herein. In some examples, aspects of the operations of 1205 may be performed by a communication component 625 as described with reference to FIG. 6. Additionally or alternatively, means for performing 1205 may, but not necessarily, include, for example, antenna 725, transceiver 715, communications manager 720, memory 730 (including code 735), processor 740, and/or bus 745.

At 1210, the method may include determining a second communication beam to use for communicating with the network entity after using the first communication beam. That is, the determined second communication beam is a beam determined for use in communicating with the network entity once the first communication beam is no longer used. The operations of 1210 may be performed in accordance with examples as disclosed herein. In some examples, aspects of the operations of 1210 may be performed by a beam prediction component 630 as described with reference to FIG. 6. Additionally or alternatively, means for performing 1210 may, but not necessarily, include, for example, antenna 725, transceiver 715, communications manager 720, memory 730 (including code 735), processor 740, and/or bus 745.

At 1215, the method may include predicting a change in a communication parameter of the UE associated with switching from the first communication beam to the second communication beam. The operations of 1215 may be performed in accordance with examples as disclosed herein. In some examples, aspects of the operations of 1215 may be performed by a parameter prediction component 635 as described with reference to FIG. 6. Additionally or alternatively, means for performing 1215 may, but not necessarily, include, for example, antenna 725, transceiver 715, communications manager 720, memory 730 (including code 735), processor 740, and/or bus 745.

At 1220, the method may include transmitting, to the network entity before switching to the second communication beam, a message that indicates the predicted change in the communication parameter and a time parameter, the time parameter indicating a time to switch to the second communication beam. The operations of 1220 may be performed in accordance with examples as disclosed herein. In some examples, aspects of the operations of 1220 may be performed by a communication component 625 as described with reference to FIG. 6. Additionally or alternatively, means for performing 1220 may, but not necessarily, include, for example, antenna 725, transceiver 715, communications manager 720, memory 730 (including code 735), processor 740, and/or bus 745.

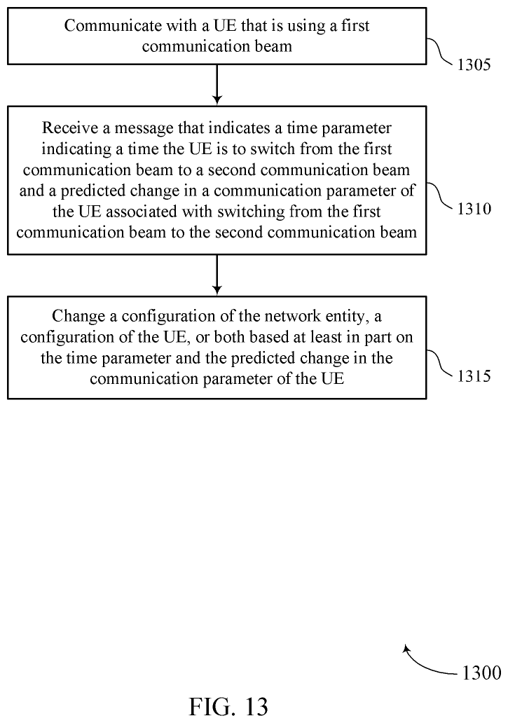

FIG. 13 shows a flowchart illustrating a method 1300 that supports beam switch prediction and reporting in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include communicating with a UE that is using a first communication beam. The operations of 1305 may be performed in accordance with examples as disclosed herein. In some examples, aspects of the operations of 1305 may be performed by a communication component 1025 as described with reference to FIG. 10. Additionally or alternatively, means for performing 1305 may, but not necessarily, include, for example, antenna 1115, transceiver 1110, communications manager 1120, memory 1125 (including code 1130), processor 1135, and/or bus 1140.

At 1310, the method may include receiving a message that indicates a time parameter indicating a time the UE is to switch from the first communication beam to a second communication beam and a predicted change in a communication parameter of the UE associated with switching from the first communication beam to the second communication beam. The operations of 1310 may be performed in accordance with examples as disclosed herein. In some examples, aspects of the operations of 1310 may be performed by a beam switch component 1030 as described with reference to FIG. 10. Additionally or alternatively, means for performing 1310 may, but not necessarily, include, for example, antenna 1115, transceiver 1110, communications manager 1120, memory 1125 (including code 1130), processor 1135, and/or bus 1140.

At 1315, the method may include changing a configuration of the network entity, a configuration of the UE, or both based on the time parameter and the predicted change in the communication parameter of the UE. The operations of 1315 may be performed in accordance with examples as disclosed herein. In some examples, aspects of the operations of 1315 may be performed by a configuration component 1035 as described with reference to FIG. 10. Additionally or alternatively, means for performing 1315 may, but not necessarily, include, for example, antenna 1115, transceiver 1110, communications manager 1120, memory 1125 (including code 1130), processor 1135, and/or bus 1140.

The following provides an overview of aspects of the present disclosure:

Aspect 1: A method for wireless communication at a UE, comprising: communicating, with a network entity, using a first communication beam; determining a second communication beam to use for communicating with the network entity after using the first communication beam; predicting a change in a communication parameter of the UE associated with switching from the first communication beam to the second communication beam; and transmitting, to the network entity before switching to the second communication beam, a message that indicates the predicted change in the communication parameter and a time parameter, the time parameter indicating a time to switch to the second communication beam.

Aspect 2: The method of aspect 1, further comprising: determining a communication beam for the network entity based at least in part on the second communication beam; and indicating the communication beam for the network entity before switching from the first communication beam to the second communication beam.

Aspect 3: The method of any of aspects 1 through 2, further comprising: requesting, before switching to the second communication beam, a set of uplink reference signal resources for transmitting an uplink reference signal using the second communication beam.

Aspect 4: The method of any of aspects 1 through 3, further comprising: requesting, before switching to the second communication beam, a downlink reference signal to measure using the second communication beam; and transmitting channel state information that is based at least in part on measuring the downlink reference signal using the second communication beam.

Aspect 5: The method of any of aspects 1 through 4, further comprising: requesting, before switching to the second communication beam, the network entity perform a beam sweep procedure after the time to switch to the second communication beam.

Aspect 6: The method of any of aspects 1 through 5, further comprising: determining, based at least in part on transmitting the message, a duration of time during which communication with the network entity is suspended, the duration of time relative to the time to switch to the second communication beam.

Aspect 7: The method of any of aspects 1 through 6, wherein the second communication beam is determined using machine learning, the method further comprising: determining a change in location of the UE, a change in orientation of the UE, a change in a physical configuration of the UE, a change in a surrounding obstruction, or any combination thereof, wherein the second communication beam is determined based at least in part on the change in location of the UE, the change in orientation of the UE, the change in a physical configuration of the UE, the change in the surrounding obstruction, or any combination thereof.

Aspect 8: The method of any of aspects 1 through 7, wherein the change in the communication parameter comprises a change in multiple-input multiple-output rank or a change in directivity gain.

Aspect 9: The method of any of aspects 1 through 8, wherein the message is transmitted according to a periodicity.

Aspect 10: The method of any of aspects 1 through 9, further comprising: determining that a threshold duration of time has elapsed since transmission of a previous message indicating a switch between communication beams, wherein the message is transmitted based at least in part on determining that the threshold duration of time has elapsed.

Aspect 11: The method of any of aspects 1 through 10, further comprising: determining that continued use of the first communication beam is associated with a first predicted signal strength that is lower than a second predicted signal strength associated with use of the second communication beam, wherein the message is transmitted based at least in part on the determination that the first predicted signal strength is lower than the second predicted signal strength.

Aspect 12: The method of any of aspects 1 through 11, further comprising: determining that a duration of time between transmission of the message and the time to switch is less than a threshold duration of time, wherein the message is transmitted based at least in part on the determination that the duration of time is less than the threshold duration of time.

Aspect 13: The method of any of aspects 1 through 12, further comprising: determining that a duration of time between transmission of the message and the time to switch is greater than a threshold duration of time, wherein the message is transmitted based at least in part on the determination that the duration of time is greater than the threshold duration of time.

Aspect 14: The method of any of aspects 1 through 13, further comprising: receiving a second message confirming receipt of the message by the network entity; and switching to the second communication beam at the time and based at least in part on receiving the second message.

Aspect 15: The method of aspect 14, wherein the message is conveyed in a physical uplink control channel, and the second message is included in downlink control information for the UE.

Aspect 16: The method of aspect 14, wherein the message is conveyed in a physical uplink shared channel, and the second message is included in an uplink grant that has a same hybrid automatic repeat request identifier as the physical uplink shared channel.

Aspect 17: The method of any of aspects 1 through 16, wherein the message is included in uplink control information or in a medium access control (MAC) control element.

Aspect 18: The method of any of aspects 1 through 17, further comprising: initiating a random access procedure, wherein the message is part of the random access procedure.

Aspect 19: A method for wireless communication at a network entity, comprising: communicating with a UE that is using a first communication beam; receiving a message that indicates a time parameter indicating a time the UE is to switch from the first communication beam to a second communication beam and a predicted change in a communication parameter of the UE associated with switching from the first communication beam to the second communication beam; and changing a configuration of the network entity, a configuration of the UE, or both based at least in part on the time parameter and the predicted change in the communication parameter of the UE.

Aspect 20: The method of aspect 19, further comprising: receiving, before the time the UE is to switch to the second communication beam, an indication of a communication beam for the network entity to use after the UE switches to the second communication beam; and communicating with the UE using the communication beam after the UE switches to the second communication beam based at least in part on the indication of the communication beam.

Aspect 21: The method of any of aspects 19 through 20, further comprising: receiving, before the time the UE is to switch to the second communication beam, a request for a downlink reference signal for the UE to measure using the second communication beam; and receiving channel state information that is based at least in part on the downlink reference signal.

Aspect 22: The method of any of aspects 19 through 21, further comprising: receiving, before the time the UE is to switch to the second communication beam, a request for the network entity to perform a beam sweep procedure after the UE switches to the second communication beam; and performing the beam sweep procedure after the UE switches to the second communication beam and based at least in part on the request.

Aspect 23: The method of any of aspects 19 through 22, further comprising: determining, based at least in part on the message, a duration of time during which to suspend communication with the UE, the duration of time relative to the time the UE is to switch to the second communication beam.

Aspect 24: The method of aspect 23, wherein the duration of time is based at least in part on a capability of the UE and a cyclic prefix length.

Aspect 25: The method of any of aspects 19 through 24, further comprising: transmitting a second message to the UE confirming receipt of the message.

Aspect 26: The method of aspect 25, wherein the message is conveyed in a physical uplink control channel, and the second message is included in downlink control information for the UE.

Aspect 27: The method of aspect 25, wherein the message is conveyed in a physical uplink shared channel, and the second message is included in an uplink grant that has a same hybrid automatic repeat request identifier as the physical uplink shared channel.

Aspect 28: The method of any of aspects 19 through 27, further comprising: performing a random access procedure with the UE, wherein the message is part of the random access procedure.

Aspect 29: An apparatus for wireless communication, comprising a memory, a transceiver, and at least one processor coupled with the memory and the transceiver, the at least one processor configured to perform a method of any of aspects 1 through 18.

Aspect 30: An apparatus for wireless communication at a UE, comprising at least one means for performing a method of any of aspects 1 through 18.

Aspect 31: A non-transitory computer-readable medium storing code for wireless communication at a UE, the code comprising instructions executable by a processor to perform a method of any of aspects 1 through 18.

Aspect 32: An apparatus for wireless communication, comprising a memory and at least one processor coupled with the memory, the at least one processor configured to perform a method of any of aspects 19 through 28.

Aspect 33: An apparatus for wireless communication at a network entity, comprising at least one means for performing a method of any of aspects 19 through 28.

Aspect 34: A non-transitory computer-readable medium storing code for wireless communication at a network entity, the code comprising instructions executable by a processor to perform a method of any of aspects 19 through 28

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
communicating, with a network entity, using a first communication beam;
determining a second communication beam to use for communicating with the network entity after using the first communication beam;
predicting a change in a communication parameter of the UE associated with switching from the first communication beam to the second communication beam; and
transmitting, to the network entity before switching to the second communication beam, a message that indicates the predicted change in the communication parameter and a time parameter, the time parameter indicating a time to switch to the second communication beam.

2. The method of claim 1, further comprising:
determining a communication beam for the network entity based at least in part on the second communication beam; and
indicating the communication beam for the network entity before switching from the first communication beam to the second communication beam.

3. The method of claim 1, further comprising:
requesting, before switching to the second communication beam, a set of uplink reference signal resources for transmitting an uplink reference signal using the second communication beam.

4. The method of claim 1, further comprising:
requesting, before switching to the second communication beam, a downlink reference signal to measure using the second communication beam; and
transmitting channel state information that is based at least in part on measuring the downlink reference signal using the second communication beam.

5. The method of claim 1, further comprising:
requesting, before switching to the second communication beam, the network entity perform a beam sweep procedure after the time to switch to the second communication beam.

6. The method of claim 1, further comprising:
determining, based at least in part on transmitting the message, a duration of time during which communication with the network entity is suspended, the duration of time relative to the time to switch to the second communication beam.

7. The method of claim 1, wherein the second communication beam is determined using machine learning, the method further comprising:
determining a change in location of the UE, a change in orientation of the UE, a change in a physical configuration of the UE, a change in a surrounding obstruction, or any combination thereof, wherein the second communication beam is determined based at least in part on the change in location of the UE, the change in orientation of the UE, the change in the physical configuration of the UE, the change in the surrounding obstruction, or any combination thereof.

8. The method of claim 1, wherein the change in the communication parameter comprises a change in multiple-input multiple-output rank or a change in directivity gain.

9. The method of claim 1, wherein the message is transmitted according to a periodicity.

10. The method of claim 1, further comprising:
determining that a threshold duration of time has elapsed since transmission of a previous message indicating a switch between communication beams, wherein the message is transmitted based at least in part on determining that the threshold duration of time has elapsed.

11. The method of claim 1, further comprising:
determining that continued use of the first communication beam is associated with a first predicted signal strength that is lower than a second predicted signal strength associated with use of the second communication beam, wherein the message is transmitted based at least in part on the determination that the first predicted signal strength is lower than the second predicted signal strength.

12. The method of claim 1, further comprising:
determining that a duration of time between transmission of the message and the time to switch is less than a threshold duration of time, wherein the message is transmitted based at least in part on the determination that the duration of time is less than the threshold duration of time.

13. The method of claim 1, further comprising:
determining that a duration of time between transmission of the message and the time to switch is greater than a threshold duration of time, wherein the message is transmitted based at least in part on the determination that the duration of time is greater than the threshold duration of time.

14. The method of claim 1, further comprising:
receiving a second message confirming receipt of the message by the network entity; and
switching to the second communication beam at the time and based at least in part on receiving the second message.

15. The method of claim 14, wherein the message is conveyed in a physical uplink control channel, and wherein the second message is included in downlink control information for the UE.

16. The method of claim 14, wherein the message is conveyed in a physical uplink shared channel, and wherein the second message is included in an uplink grant that has a same hybrid automatic repeat request identifier as the physical uplink shared channel.

17. The method of claim 1, wherein the message is included in uplink control information or in a medium access control (MAC) control element.

18. The method of claim 1, further comprising:
initiating a random access procedure, wherein the message is part of the random access procedure.

19. A method for wireless communication at a network entity, comprising:
communicating with a user equipment (UE) that is using a first communication beam;
receiving a message that indicates a time parameter indicating a time the UE is to switch from the first communication beam to a second communication beam and a predicted change in a communication parameter of the UE associated with switching from the first communication beam to the second communication beam; and
changing a configuration of the network entity, a configuration of the UE, or both based at least in part on the time parameter and the predicted change in the communication parameter of the UE.

20. The method of claim 19, further comprising:
receiving, before the time the UE is to switch to the second communication beam, an indication of a communication beam for the network entity to use after the UE switches to the second communication beam; and
communicating with the UE using the communication beam after the UE switches to the second communication beam based at least in part on the indication of the communication beam.

21. The method of claim 19, further comprising:
receiving, before the time the UE is to switch to the second communication beam, a request for a downlink reference signal for the UE to measure using the second communication beam; and
receiving channel state information that is based at least in part on the downlink reference signal.

22. The method of claim 19, further comprising:
receiving, before the time the UE is to switch to the second communication beam, a request for the network entity to perform a beam sweep procedure after the UE switches to the second communication beam; and
performing the beam sweep procedure after the UE switches to the second communication beam and based at least in part on the request.

23. The method of claim 19, further comprising:
determining, based at least in part on the message, a duration of time during which to suspend communication with the UE, the duration of time relative to the time the UE is to switch to the second communication beam.

24. The method of claim 23, wherein the duration of time is based at least in part on a capability of the UE and a cyclic prefix length.

25. The method of claim 19, further comprising:
transmitting a second message to the UE confirming receipt of the message.

26. The method of claim 25, wherein the message is conveyed in a physical uplink control channel, and wherein the second message is included in downlink control information for the UE.

27. The method of claim 25, wherein the message is conveyed in a physical uplink shared channel, and wherein the second message is included in an uplink grant that has a same hybrid automatic repeat request identifier as the physical uplink shared channel.

28. The method of claim 19, further comprising:
performing a random access procedure with the UE, wherein the message is part of the random access procedure.

29. An apparatus for wireless communication, comprising:
memory;
a transceiver; and
at least one processor of a user equipment (UE), the at least one processor coupled with the memory and the transceiver, and the at least one processor configured to:
communicate, with a network entity via the transceiver, using a first communication beam;
determine a second communication beam to use for communicating with the network entity after using the first communication beam;
predict a change in a communication parameter of the UE associated with switching from the first communication beam to the second communication beam; and
transmit, to the network entity via the transceiver and before switching to the second communication beam, a message that indicates the predicted change in the communication parameter and a time parameter, the time parameter indicating a time to switch to the second communication beam.

30. An apparatus for wireless communication, comprising:
memory; and
at least one processor of a network entity, the at least one processor coupled with the memory and configured to:
communicate with a user equipment (UE) that is using a first communication beam;
receive a message that indicates a time parameter indicating a time the UE is to switch from the first communication beam to a second communication beam and a predicted change in a communication parameter of the UE associated with switching from the first communication beam to the second communication beam; and
change a configuration of the network entity, a configuration of the UE, or both based at least in part on the time parameter and the predicted change in the communication parameter of the UE.
